(19) United States
(12) Patent Application Publication
(10) Pub. No.: US 2004/0057337 A1
(43) Pub. Date: Mar. 25, 2004

(54) Circulation device

(76) Inventors: Walter Hofmuth, Munchen (DE); Anton Pirmann, Munchen (DE)

Correspondence Address: HOFFMAN WARNICK & D'ALESSANDRO, LLC, 3 E-COMM SQUARE, ALBANY, NY, 12207

(21) Appl. No.: 10/659,846

(22) Filed: Sep. 11, 2003

(30) Foreign Application Priority Data
Sep. 20, 2002 (EP) 02020983.9

(51) Int. Cl. B01F 5/10

(52) U.S. Cl. 366/167.1

(57) ABSTRACT

A circulation device for circulating a liquid in a treatment vessel, in particular in a treatment vessel for treating light-sensitive material. The circulation device has a feed pipe arranged roughly vertically in the treatment vessel, through which liquid from a feed line can flow into the treatment vessel. The flow cross-section (A) of the feed pipe is dimensioned so that the liquid flowing in from the feed line backs up in the feed pipe and produces a hydrostatic pressure that is such that the liquid flowing from the outlet opening of the feed pipe produces a circulation movement of the liquid in the treatment vessel.

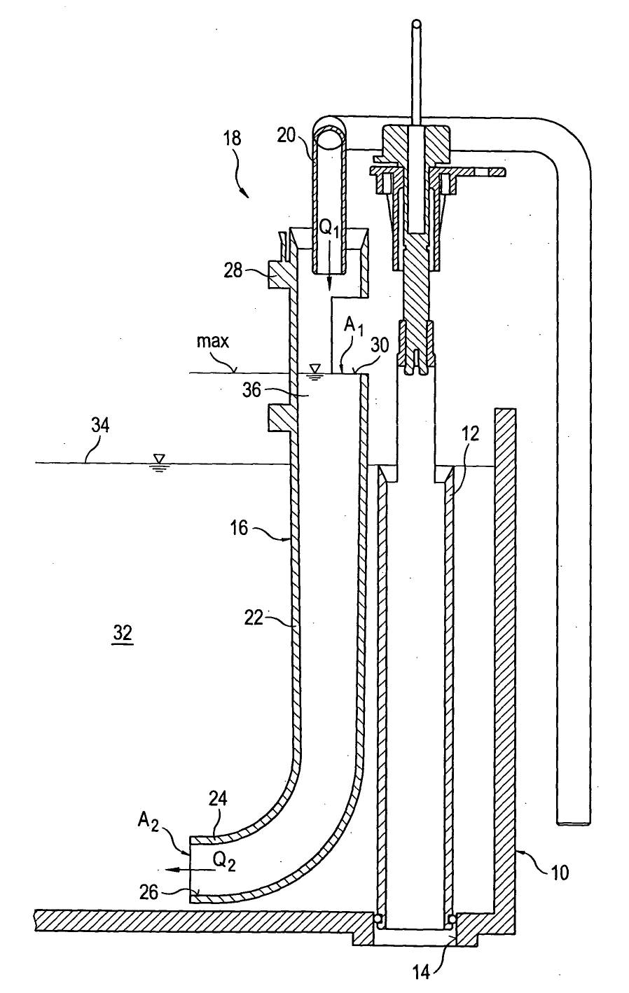

### FIELD OF THE INVENTION

The invention relates to a circulation (circulation-promoting) device for circulating a liquid in a treatment vessel, in particular in a treatment vessel for treating light-sensitive material.

### BACKGROUND OF THE INVENTION

When treating light-sensitive material, for example a light-sensitive film such as an X-ray film that is to be developed, fixed and rinsed, it is important to circulate the liquid in which the light-sensitive material is treated. The circulating movement is intended to ensure that concentration differences of the reactants in the treatment liquid are compensated. In addition, there is for example the problem that when developing light-sensitive films a boundary layer is formed on the film surface during the transportation of the film through the treatment vessel, the reactivity of the reactants being reduced in the layer due to the reactions that have already taken place, whereas the ambient liquid contains a higher concentration of the reactants.

The exact opposite occurs in the rinsing procedure. In this case a boundary layer with a high concentration of reactants is formed, whereas the ambient liquid is cleaner and is more receptive to the substances to be rinsed off.

In order to circulate the liquid in such treatment vessels, the circulation device has functional units such as circulation wheels, circulation pumps and the like.

However, especially when circulating liquids that contain very reactive substances, such as for example the developer solutions and fixing solutions used to develop light-sensitive materials, the problem arises that the functional units are subjected to an aggressive working environment. Furthermore the liquids are normally additionally heated in order to increase the reaction velocity, thereby further increasing their corrosive effect. The high reactivity of the reactants leads in turn to corrosion and premature wear and tear of the functional units. In order to prevent as far as possible the actual drive systems of the functional units coming into contact with these aggressive reactants, various possibilities are available in the prior art for indirectly driving the circulation devices arranged in the treatment vessel.

For example, in German Utility Model DE 94 13 783 U1 it is proposed to arrange outside the treatment vessel a rotating-field motor that drives a circulation pump by means of permanent magnets that are provided on the circulation pump arranged in the treatment vessel and with the aid of its rotating field, in order to circulate the liquid.

In German Utility Model DE 89 08 038 U1 pump gyromagnets are arranged on a circulation pump provided in the treatment vessel, which are caused to drive the circulation pump by means of driven drive magnets arranged facing one another outside the treatment vessel.

The disadvantage of these known devices is that the functional units arranged in the treatment vessel, for example the circulation pump or corresponding circulation wheels, as well as their bearings, are still subjected to the aggressive treatment liquids in the treatment vessel and therefore very quickly tend to suffer from wear and tear. In addition, due to the high degree of contamination, for example due to algae formation, there is the danger that such movable functional units will seize up. All this leads to short maintenance cycles and to a frequent replacement of such functional units arranged in the treatment vessel.

### SUMMARY OF THE INVENTION

The present invention provides a circulation device of the type mentioned in the introduction in which a sufficient circulation movement can be achieved in the treatment vessel in a simple manner and with comparatively little effort and expenditure.

In the circulation device according to the invention the circulation movement of the liquid in the treatment vessel is effected by the purposeful inflow of additional liquid (replenishment liquid) into the treatment vessel. To this end the invention proposes the use of a roughly vertically arranged feed pipe through which additional liquid from a feed line flows into the treatment vessel. The flow cross-section of the feed pipe is in this connection dimensioned so that the liquid flowing in from the feed line first of all backs up in the feed pipe. A hydrostatic pressure is produced by this backing-up of the liquid in the feed pipe, this pressure being adjusted according to the invention by the shape of the feed pipe so that the liquid exiting from the outlet opening of the feed pipe flows into the treatment vessel at a flow velocity that generates a sufficient circulation movement of the liquid in the treatment vessel. By employing the feed pipe according to the invention the use of complicated functional units in the treatment vessel, such as circulation wheels, circulation pumps and the like, can be avoided. At the same time a possible exchange or also a replacement of already existing circulation devices and a modification with the feed pipe according to the invention can be accomplished in a simple way.

In a particularly preferred embodiment of the circulation device the feed pipe is designed so that with a filling height in the feed pipe that lies between the level of the liquid in the treatment vessel and a maximum filling height of the feed pipe, an equilibrium state is established between the hydrostatic pressure of the liquid column and the backing-up pressure at the outlet opening of the feed pipe. This means that, at this filling height, the liquid stream flowing from the outlet opening corresponds approximately to the liquid stream flowing into the inflow section. Due to this design feature it is ensured that at the feed pipe an equilibrium is established between the liquid stream flowing into the inflow section and the liquid stream flowing from the outlet opening, whereby depending on the inflowing liquid stream the outflow velocity from the outlet opening is increased or reduced by a defined amount corresponding to the predetermined cross-sectional ratios.

The ratio of the flow cross-section of the inflow section at the height of the maximum filling level of the liquid column to the flow cross-section of the outlet opening is preferably in a range from 3:2 to 3:1. Thus, it has been found in experiments that if these cross-sectional ratios are maintained then a flow velocity of the liquid stream flowing from the outlet opening can be achieved that is sufficient for a circulation movement.

Furthermore, in the aforedescribed embodiment it is proposed to design the outflow section, at whose open end the outlet opening is formed and which is connected to the inflow section, with a tapering flow cross-section. The formation of turbulent flows in the feed pipe is prevented by means of this preferably continuous cross-sectional reduction of the feed pipe.

In order to achieve as optimal a circulation movement in the treatment vessel as possible, in a development of this embodiment involving a tapering outflow section it is furthermore proposed to design the outflow section in a curved manner so that the flow direction of the liquid flowing from the outlet opening is aligned roughly parallel to the floor of the treatment vessel. This flow aligned parallel to the floor of the treatment vessel induces a circulation movement of all the liquid in the treatment vessel and is therefore primarily responsible for the desired circulation movement.

In order to prevent a possible backflow of liquid into the feed line, in an embodiment of the circulation device according to the invention it is furthermore proposed to provide at the inflow section an overflow opening that defines the maximum filling height of the liquid column in the inflow section. If for example replenishment liquid were to reach the feed pipe too quickly or the outlet opening were to become overloaded or blocked, the liquid can escape through this overflow opening from the feed pipe into the treatment vessel, so that a reverse flow of liquid into the feed line can be purposefully prevented. This is particularly important if no chemicals are added to the liquid that flows through the feed line into the treatment vessel, and a contamination of the feed line by chemicals-containing liquid from the treatment vessel is to be avoided.

In order to prevent chemicals-containing liquid from the treatment vessel rising up the feed line, it is furthermore advantageous to allow the feed line to project, at a distance from the inner walls of the feed pipe, into the inflow section, which ensures that liquid that may possibly rise up the inner walls of the feed pipe does not come into contact with the actual feed line. As a further measure it is also proposed to provide a non-return valve on the feed line.

In a particularly preferred embodiment the circulation device additionally has a sensor by means of which light-sensitive material that is added to the treatment vessel is detected. The sensor is in turn coupled to an adjustment unit for actuating the feed line, which as soon as the sensor recognises that light-sensitive material is added to the treatment device, opens the otherwise closed feed line. This measure is intended to ensure that the amount of liquid absorbed by the light-sensitive material and removed from the treatment vessel, if the light-sensitive material is conveyed again from the treatment vessel, is compensated. On the other hand, spent liquid should also be able to be replaced by fresh replenishment liquid. Accordingly, a replenishment amount relating to the size of the film to be treated is usually specified, by means of which the consumption of chemicals in the treatment vessel and the entrainment of liquid from the treatment vessel by the light-sensitive material is taken into account. The coupling according to the invention of the feed line to the sensor ensures that the feed line is regulated via the light-sensitive material itself, whereby the presence of a light-sensitive material is detected and the feed through the treatment vessel is appropriately adjusted, depending on the replenishment quota and the size of the light-sensitive material.

An outflow is provided in the treatment vessel, through which liquid is displaced from the treatment vessel by the added amount of replenishment liquid flowing in through the feed pipe. In this way a replenishment of the liquid in the treatment vessel can be achieved in a purposeful way. At the same time the outflow is preferably formed as an overflow pipe that is provided in the treatment vessel.

### BRIEF DESCRIPTION OF THE DRAWINGS

Further features and advantages of the invention will become evident from the following description of a preferred embodiment, reference being made to the accompanying drawing.

The single FIGURE is a side view partially in section of a treatment vessel for light-sensitive material, which is equipped with a circulation device according to the invention.

### DETAILED DESCRIPTION OF THE INVENTION

The single FIGURE shows in section a treatment vessel 10 for a light-sensitive material (not shown), such as a film to be developed. In the treatment vessel 10 an overflow pipe 12 is provided in the vicinity of one of its side walls, which is inserted in a sealed manner into an outflow opening 14 of the treatment vessel 10. A feed pipe 16 of a circulation device 18 is positioned immediately adjacent to the overflow pipe 12. A feed line 20 is provided above the feed pipe 16 and projects into the inflow section 22 of the feed pipe 16.

The inflow section 22 tapers continuously in its longitudinal direction and transforms into an outflow section 24. The outflow section 24 forms a 90° bend, so that the outlet opening 26 formed at its end runs in a plane roughly perpendicular to the floor of the treatment vessel 10. In addition, a holding device 28 is provided at the inflow section 22 of the feed pipe 16 by means of which the feed pipe 16 is secured to a support (not shown) on the treatment vessel 10. In this way it is very easy to install or dismantle the feed pipe 16, in order for example to clean the feed pipe 16 or to replace it by a new feed pipe 16. Moreover, already existing treatment vessels 10 can if necessary be modified or adjusted without any problem by this measure since a corresponding support on which the feed pipe 16 can be suspended simply has to be secured to the existing treatment vessel 10. In addition an overflow opening 30, the purpose of which will be explained in more detail later, designed as a cut-out section is formed at the inflow section 22.

The treatment vessel 10 is filled with a liquid 32 for treating the light-sensitive material. In this connection this may for example be a developer solution, a fixing solution or a rinse liquid, through which the light-sensitive material, for example a film, is continuously drawn. The treatment vessel 10 is filled with the liquid 32 to such a height as to establish a liquid level 34. The liquid level 34 is in this connection limited by the overflow pipe 12, the upper side of which is open. As soon as the liquid 32 in the treatment vessel 10 rises above the specified liquid level 34, a corresponding amount of the liquid 32 flows through the upwardly open overflow pipe 12 from the treatment vessel 10, from the outflow opening 14, until the height of the liquid again reaches the specified liquid level 34.

In order to achieve a circulation movement in the treatment vessel 10, additional liquid is introduced through the feed line 20 and the feed pipe 16 into the treatment vessel 10. On account of the dimensioning and shape of the feed pipe 16 the liquid backs up in the feed pipe 16, leading to the formation of a liquid column 36 in the inflow section 22. The maximum filling height “max” of the liquid column 36 is in this connection limited by the overflow opening 30. If the liquid in the inflow section 22 were to rise above the maximum filling height “max” in the feed pipe 16, then the liquid flows through the overflow opening 30 from the feed pipe 16 and into the treatment vessel 10. The liquid flowing from the overflow opening 30 into the treatment vessel 10 either displaces a corresponding amount of the liquid 32 already contained in the treatment vessel 10, which liquid flows through the overflow pipe 12, from the treatment vessel 10 or flows away through the overflow pipe 12 arranged immediately adjacent to the feed pipe 16, directly from the treatment vessel 10.

Due to the liquid column 36 forming in the inflow section 22 during the filling procedure, then under a continuous further flow of a liquid stream Q₁, an outflowing liquid stream Q₂ is produced at the outlet opening 26. This is effected by the hydrostatic pressure produced by the liquid column 36. The flow velocity of the outflowing liquid stream Q₂ is in this connection dependent on the flow cross-section A₁ of the inflow section 22 at the level of the maximum filling height “max” of the liquid column 36 and the flow cross-section A₂ of the outflow opening 26. The ratio of these two flow cross-sections A₁:A₂ is in the illustrated embodiment in the region of 3:2.

Due to the continuous reduction of the flow cross-section, as already previously explained a correspondingly increased outflow velocity of the liquid at the outlet opening 26 is produced. Due to this increased outlet velocity of the liquid from the outlet opening 26 a circulation movement of the liquid 32 in the treatment vessel 10 is in turn generated. The amount of liquid flowing in through the feed pipe 16 displaces a corresponding amount of the liquid 32 from the treatment vessel 10 through the overflow pipe 12. In this way a continuous circulation movement of the liquid 32 in the treatment vessel 10 can be achieved.

In a preferred embodiment of the circulation device 18 according to the invention the device additionally comprises a sensor (not shown), which responds as soon as light-sensitive material is added. Depending on the width and length of the added light-sensitive material, and based on the amount of liquid 32 that adheres to the light-sensitive material and that is transported from the treatment vessel 10 during passage of the material through the vessel 10, and based on the consumption of liquid, a replenishment can be carried out. By coupling the aforedescribed sensor (not shown) to an adjustment device (likewise not shown) provided on the feed line 20, the amount of liquid that flows through the feed line 20 into the feed pipe 16 can thereby be adjusted depending on the previously described replenishment quota.

1. A circulation device for circulating a liquid in a treatment vessel for treating light-sensitive material, wherein the circulation device has a feed pipe arranged roughly vertically in the treatment vessel through which liquid can flow in from a feed line into the treatment vessel, a flow cross-section (A) of the feed pipe being dimensioned so that the inflowing liquid from the feed line backs up in the feed pipe and generates a hydrostatic pressure which is such that outflowing liquid from an outlet opening of the feed pipe produces a circulation movement of the liquid in the treatment vessel.

2. The circulation device as claimed in claim 1, wherein the inflow section of the feed pipe in which a liquid column is formed has at the height of a maximum filling level of the liquid column a flow cross-section (A₁) that is dimensioned in relation to the flow cross-section (A₂) of the outlet opening so that a liquid stream (Q₂) flowing from the outlet opening corresponds roughly to a liquid stream (Q₁) flowing into the inflow section at the maximum filling level in the inflow section.

3. The circulation device as claimed in claim 2, wherein a ratio of the flow cross-section (A₁) of the inflow section at the height of the maximum filling level of the liquid column to the flow cross-section (A₂) of the outlet opening is in a range from 3:2 to 3:1.

4. The circulation device as claimed in claim 2, wherein the inflow section has a tapering flow cross-section and transforms into an outflow section with a tapering flow cross-section, whose open end forms the outlet opening.

5. The circulation device as claimed in claim 4, wherein the outflow section is curved so that the flow direction of the liquid flowing from the outlet opening is aligned roughly parallel to a floor of the treatment vessel.

6. The circulation device as claimed in claim 2, wherein an overflow opening that defines the maximum filling level of the liquid column in the inflow section is provided at the inflow section.

7. The circulation device as claimed in claim 1, wherein the feed pipe is positioned in the treatment vessel in such a way that the feed line projects, spaced from inner walls of the feed pipe, into the inflow section.

8. The circulation device as claimed in claim 7, wherein a non-return valve is provided in the feed line.

9. The circulation device as claimed in claim 1, wherein the circulation device has a sensor for detecting light-sensitive material and an adjustment unit coupled to the sensor for actuating the feed line, the adjustment unit opening the otherwise closed feed line when it detects light-sensitive material.

10. The circulation device as claimed in claim 1, wherein the liquid flowing in through the feed pipe displaces liquid from the treatment vessel through an outflow provided in the treatment vessel.

11. The circulation device as claimed in claim 10, wherein an overflow pipe is provided as outflow in the treatment vessel, adjacent to the feed pipe.
